(19) United States
(12) Patent Application Publication
(10) Pub. No.: US 2026/0159412 A1
(43) Pub. Date: Jun. 11, 2026

(54) MICROSPHERES, LITHIUM ION BATTERY ANODE COMPRISING SAME, AND METHOD FOR MANUFACTURING MICROSPHERES

(71) Applicant: CHUNGBUK NATIONAL UNIVERSITY INDUSTRY-ACADEMIC COOPERATION FOUNDATION, Cheongju-si Chungcheongbuk-do (KR)

(72) Inventor: Jung Sang CHO, Cheongju-si (KR)

(21) Appl. No.: 18/716,319

(22) PCT Filed: Jun. 30, 2022
(86) PCT No.: PCT/KR2022/009378

§ 371 Date: Jun. 4, 2024

(30) Foreign Application Priority Data
Dec. 6, 2021 (KR) 10-2021-0173045

(51) Int. Cl. C01G 39/02; H01M 4/02; H01M 4/485; H01M 10/0525

(52) U.S. Cl. CPC C01G 39/02; H01M 4/485; C01P 2002/52; C01P 2002/72; C01P 2004/03; C01P 2004/04; C01P 2004/16; C01P 2004/34; C01P 2004/62; C01P 2004/64; C01P 2006/40; H01M 2004/021; H01M 2004/027; H01M 10/0525

(57) ABSTRACT

Microspheres of the present invention may comprise: hollow carbon; and a transition metal oxide disposed on the surface of the hollow carbon. A lithium ion battery anode of the present invention may comprise the microspheres. A method for manufacturing microspheres of the present invention may comprise the steps of: mixing a metal salt, a carbon precursor, and an ammonium ion precursor to obtain a spray solution; and subjecting the spray solution to one-pot spray pyrolysis.

### TECHNICAL FIELD

The present invention relates to microspheres having a novel structure, an anode for a lithium ion battery including the same, and a method of manufacturing microspheres.

### BACKGROUND ART

With the rapid increase in energy demand, lithium ion batteries (LIBs) are receiving attention as next-generation energy storage devices and vehicle energy sources. Therefore, it is essential to develop innovative anode materials to improve LIB performance. Due to unique structural and physicochemical properties, hollow microspheres are capable of providing a larger surface area and more active sites for lithium ion adsorption and shortening the diffusion path of lithium ions and electrons during cycling, and are in the spotlight as an anode material.

Accordingly, research is ongoing into simple and easy synthesis methods that may stably manufacture and produce hollow microspheres.

### DISCLOSURE

### Technical Problem

An object of the present invention is to provide sea urchin-like novel microspheres with high structural stability and excellent properties as a LIB anode material, an anode for a lithium ion battery including the same, and a method of manufacturing microspheres.

### Technical Solution

In order to accomplish the object of the present invention as described above, the present invention provides microspheres including hollow carbon and a transition metal oxide disposed on the surface of the hollow carbon.

In addition, the present invention provides an anode for a lithium ion battery including the microspheres.

In addition, the present invention provides a method of manufacturing microspheres, including obtaining a spray solution by mixing a metal salt, a carbon precursor, and an ammonium ion precursor and subjecting the spray solution to one-pot spray pyrolysis.

### Advantageous Effects

According to the present invention, microspheres exhibit excellent lithium ion storage properties, and the unique hollow and porous structure thereof mitigates large volume changes and facilitates electrolyte penetration. Moreover, N-doped C and transition metal oxide nanorods contribute to increasing electrical conductivity of the electrode, leading to fast charge transfer during cycling. The transition metal oxide nanorods that make up the shell enable fast lithium ion diffusion and improve electrical contact between microspheres.

Specifically, the hollow and porous structure can effectively accommodate volume expansion induced by repeated intercalation/deintercalation of Li⁺ ions, N-doped C with high electrical conductivity can induce fast charge transfer during cycling, and MoOₓ nanorods that make up the shell enable fast lithium ion diffusion, resulting in high specific capacity and stable cycling performance.

In addition, a method of manufacturing microspheres according to the present invention is capable of manufacturing microspheres with a novel structure by one-pot spray pyrolysis without a subsequent heat treatment process. The microspheres of the present invention can be manufactured in ones of seconds by a single spray pyrolysis process. Microspheres with a novel structure can be mass-produced in a short time using a simple method, which has high potential for industrial use.

### DESCRIPTION OF DRAWINGS

FIG. 1 schematically shows a microsphere according to an embodiment of the present invention and a process of manufacturing the same;

FIG. 2 schematically shows a mechanism of formation of one-dimensional rod-shaped MoO₃ crystals;

FIG. 3 shows a spray pyrolysis system used in Example;

FIG. 4 shows digital images, morphologies, and XRD patterns of powder obtained after spray pyrolysis at various temperatures;

FIG. 5 shows FE-SEM images and XRD patterns of powder obtained after spray pyrolysis of spray solutions having various compositions;

FIGS. 6(a), 6(b), and 6(c) show FE-SEM images of microspheres according to an embodiment, FIGS. 6(d), 6(e), 6(f) and 6(g) show HR-TEM images, FIG. 6(h) shows the SAED pattern, FIG. 6(i) shows the Raman spectrum, and FIG. 6(j) shows the elemental mapping image;

FIG. 7(a) shows results of cyclic voltammetry (CV) in Example, FIG. 7(b) shows the initial discharge-charge profile, FIG. 7(c) shows the cycling performance at a current density of 0.2 A g⁻¹, FIG. 7(d) shows the cycling performance at a current density of 1.0 A g″ 1, and FIG. 7(e) shows the rate performance;

FIG. 8 shows an initial discharge/charge curve at a current density of 0.2 A g⁻¹; and

FIGS. 9(a), 9(c), and 9(e) show Nyquist impedance plots, and FIGS. 9(b), 9(d), and 9(f) show FE-SEM images.

### BEST MODE

Hereinafter, various embodiments of the present document will be described with reference to the accompanying drawings. The examples and terms used herein are not intended to limit the technology described in this document to specific embodiments, but it should be understood to cover various modifications, equivalents, and/or substitutes of the embodiments.

Hereinafter, a detailed description will be given of embodiments of the present invention with reference to the accompanying drawings.

Microspheres according to various embodiments of the present invention may have a sea urchin-like shape. Specifically, the microspheres may include hollow carbon and a transition metal oxide disposed on the surface of the hollow carbon.

Here, the transition metal oxide may be nanorod-shaped. The nanorod may have a rectangular parallelepiped shape, namely a rod shape, with a width of 20 nm to 80 nm and a height of 200 nm to 500 nm. Transition metal oxide nanorods may be in a form grown in the Z-axis from hollow carbon. These nanorods may be in a form grown in length from hollow carbon.

The transition metal oxide nanorods may be attached to the surface of hollow carbon to form a microsphere shell.

The transition metal oxide may be at least one selected from the group consisting of MoOₓ, NiO, SnO₂, Co₃O₄, WO₃, NbO, TiO₂, and Fe₂O₃. Preferably, the transition metal oxide includes MoO₃. For example, the transition metal oxide may include α-MoO₃ and β-MoO₃.

Hollow carbon may be hollow. Hollow carbon may serve to bond transition metal oxide nanorods. The hollow carbon may be N-doped carbon.

The microspheres may include 2.0 wt % to 5.0 wt % of carbon and 1.5 wt % to 3.5 wt % of nitrogen based on the total weight thereof. Since the microspheres of the present invention include carbon in an optimal weight, electrical conductivity may be increased and capacity limitation may be minimized. In particular, electrical conductivity may be improved through N doping.

The microspheres described above are a new construct that has never been reported before, and have a stable structure, large specific surface area, and excellent electrical conductivity, and may thus be used in various fields such as secondary batteries, biomaterials, catalysts, sensors, etc. Preferably, the microspheres are used as a LIB anode material. In addition, the microspheres of the present invention may be manufactured in ones of seconds by one-pot spray pyrolysis without a subsequent heat treatment process.

An anode for a lithium ion battery according to various embodiments of the present invention may include the microspheres described above. The microspheres of the present invention have excellent lithium ion storage properties and enable fast lithium ion diffusion, thereby ensuring performance and stability of the anode for lithium ion batteries.

Below is a description of a method of manufacturing microspheres according to various embodiments of the present invention.

The microspheres of the present invention may be manufactured by one-pot spray pyrolysis without a subsequent heat treatment process. The microspheres of the present invention may be manufactured in ones of seconds by a single spray pyrolysis process.

Specifically, the method of manufacturing the microspheres according to the present invention may include obtaining a spray solution by mixing a metal salt, a carbon precursor, and an ammonium ion precursor, and subjecting the spray solution to one-pot spray pyrolysis.

The metal salt may be at least one selected from the group consisting of salts of Mo, Ni, Sn, Co, W, Nb, Ti, and Fe.

The carbon precursor may include at least one selected from the group consisting of PVP (polyvinylpyrrolidone), PEDOT (polyethylenedioxythiophene), PAN (polyacrylonitrile), PAA (polyacrylic acid), PVA (polyvinyl alcohol), PMMA (polymethyl methacrylate), PVDF (polyvinylidene fluoride), PVAc (polyvinyl acetate), PS (polystyrene), PVC (polyvinyl chloride), PEI (polyetherimide), PBI (polybenzimidazole), PEO (polyethylene oxide), PCL (poly e-caprolactone), PA-6 (polyamide-6), PTT (polytrimethylene terephthalate), PDLA (poly D,L-lactic acid), polycarbonate, polydioxanone, polyglycolide, and dextran.

The ammonium ion precursor may include diethylenetriamine (DETA).

During spray pyrolysis, droplets may be generated from the spray solution using an ultrasonic nebulizer, the generated droplets may be transported to a reactor, and then pyrolysis may be carried out in the reactor. Here, spray pyrolysis may be performed at a temperature of 600° C. to 1000° C. Preferably, spray pyrolysis is carried out at a temperature of 750° C. to 850° C. Within the above temperature range, sea urchin-like microspheres may be manufactured. Specifically, microspheres including hollow carbon and transition metal oxide nanorods as a shell may be manufactured in the above temperature range. If the temperature falls outside the above range, aggregation may occur due to sintering, or all carbon may decompose and the transition metal oxide may grow in a cubic shape rather than a nanorod shape.

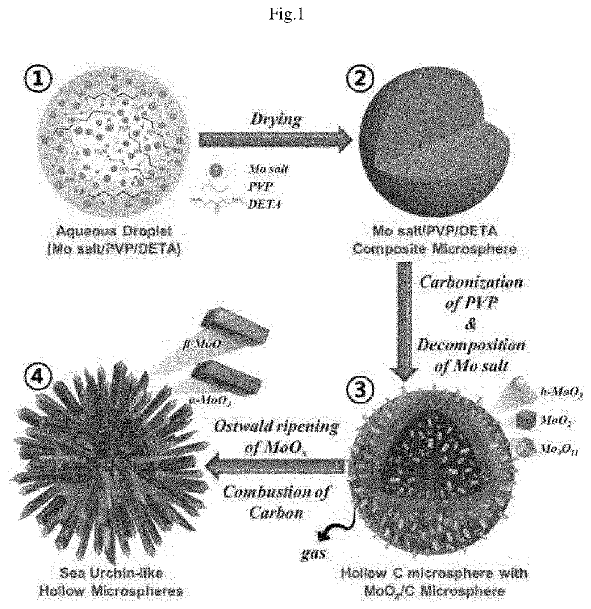

Meanwhile, referring to FIG. 1, the mechanism of formation of microspheres according to an embodiment of the present invention will be described in more detail.

Referring to \textcircled{1} in FIG. 1, a droplet composed of uniformly distributed Mo salt, PVP, and DETA is generated by an ultrasonic nebulizer during spray pyrolysis. Then, the droplet is allowed to pass through a vertical quartz reactor tube maintained at 800° C. in an ambient atmosphere, whereby the droplet is dried, forming a composite microsphere including Mo salt/PVP/DETA as shown in \textcircled{2} in FIG. 1.

Thereafter, when the droplet passes through the reactor together with a carrier gas, various reactions occur simultaneously, forming a multiphase MoOₓ/C composite hollow microsphere as shown in \textcircled{3} in FIG. 1. The Mo salt of the composite microsphere is non-uniformly oxidized and grows in the presence of DETA, producing multiphase rod-shaped MoOₓ (h-MoO₃, MoO₂, Mo₄O₁₁) crystals. Simultaneously, the continuous PVP phase of the sphere is decomposed into carbon by the Ostwald ripening process, forming a hollow carbon matrix shell.

Referring to \textcircled{4} in FIG. 1, during continuous reaction, the carbon matrix shell is partially burned to optimize the amount of carbon in the composite, coating and entangling MoOₓ nanorods. Moreover, MoOₓ (h-MoO₃, MoO₂, Mo₄O₁₁) crystals grow and are converted into a stable MoOₓ phase. Thereby, a sea urchin-like hollow microsphere with MoOₓ nanorods attached to N-doped carbon is finally formed.

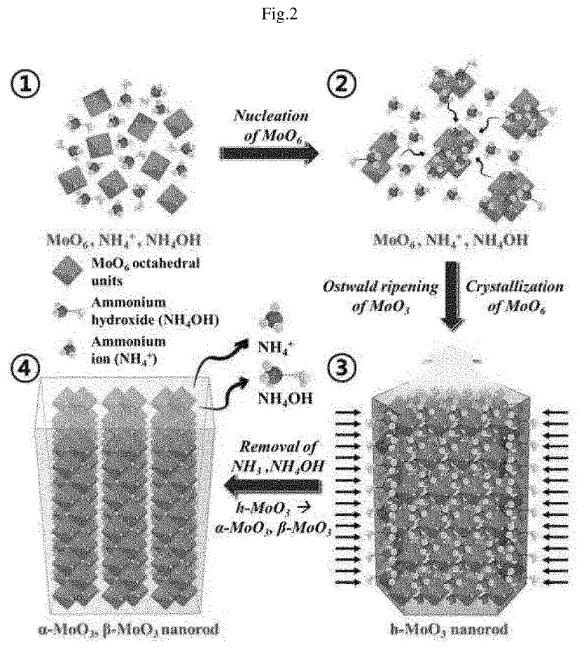

Meanwhile, referring to FIG. 2, the mechanism of formation of nanorod-shaped MoOₓ in the presence of DETA is described.

Referring to FIG. 2, a Mo salt dissociates into Mo₇O₂₄⁺ and NH₄⁺ ions, which bind to form MoO₆ octahedral crystal units. Simultaneously, DETA, a key material, is hydrolyzed to ammonia molecules (NH₃), forming a hydrogen bond with H₂O, yielding ammonium hydroxide (NH₄OH). Therefore, referring to \textcircled{1} in FIG. 2, MoO₆ octahedral crystals, NH₄OH, and residual ammonium ions (NH₄⁺) are uniformly dispersed in droplets. Thereafter, referring to \textcircled{2} in FIG. 2, the MoO₆ crystals are integrated through electrostatic attraction between the oxygen atoms and the NH₃ and NH₄⁺ ions of NH₄OH in the droplets. Thereafter, referring to \textcircled{3} in FIG. 2, as the reaction progresses, integration of MoO₆ in the a-direction is hindered by electrostatic repulsion between the H₂O molecules of NH₄OH and the MoO₆ octahedron, resulting in anisotropic growth of hexagonal MoO₃ (h-MoO₃) nuclei. Here, the H₂O portion of NH₄OH plays an important role in the growth of MoO₃ crystals in the z-axis, which may be achieved by the addition of DETA. Therefore, h-MoO₃ nuclei are continuously integrated by Ostwald ripening, forming large one-dimensional rod-shaped h-MoO₃. Referring to \textcircled{4} in FIG. 2, as the reaction temperature increases, NH₄OH and NH₄⁺ ions are completely removed from the inside of the h-MoO₃ structure. Finally, the metastable h-MoO₃ phase is converted into stable orthorhombic MoO₃ (α-MoO₃) and monoclinic MoO₃ (β-MoO₃) phases with a one-dimensional rod shape.

In the present invention, microspheres with a novel structure may be manufactured in a simple manner by one-pot spray pyrolysis. In addition, microspheres with this novel structure may be mass-produced in a short time, making them highly likely to be used industrially.

A better understanding of the present invention may be obtained through the following examples. There examples are merely set forth to illustrate the present invention and are not to be construed as limiting the present invention.

### Example

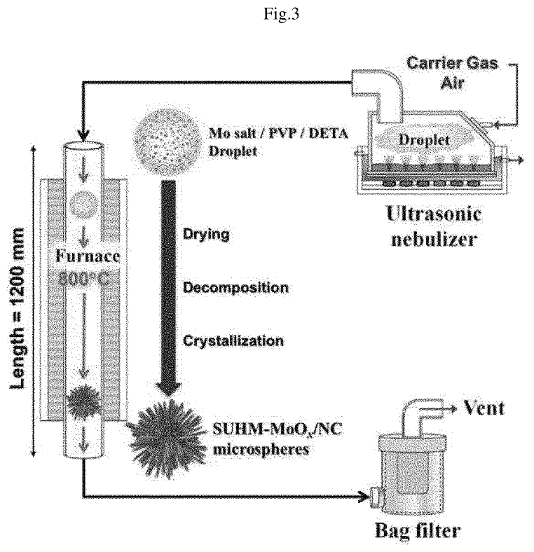

Sea urchin-like hollow microspheres (hereinafter referred to as ‘SUHM-MoOₓ/NC’) with MoOₓ nanorods attached to the surface of N-doped C according to an embodiment of the present invention were manufactured by one-pot spray pyrolysis. A spray solution was prepared by adding 0.3 M of (NH₄)₆Mo₇O₂₄·4H₂O (DAEJUNG, >98.0%, Mw=1235.86) and 27 g of PVP (DAEJUNG, Mw=40,000) to 1.0 L of distilled water. Then, 233 g of DETA (SAMCHUN, 98.5%, Mw=103.17) was added to the solution and stirred vigorously to obtain a clear spray solution. Subsequently, a spray pyrolysis process was performed to synthesize SUHM-MoOₓ/NC using the prepared spray solution. The spray pyrolysis system used in Example is shown in FIG. 3. In the spray pyrolysis system, droplets were generated using a 1.7 MHz ultrasonic nebulizer having six vibrators. The droplets were transported to a quartz reactor (length=1200 mm, diameter=50 mm) by air carrier gas at a flow rate of 18 L min⁻¹. The reactor temperature was maintained at 800° C.

On the other hand, for comparison, two types of bare MoOₓ particles having a full structure were also prepared by spray pyrolysis. Full bare MoO₃ nanocubes (hereinafter referred to as ‘F-MoO₃ nanocubes’) were manufactured by spray pyrolysis using the same spray solution as in Example at a higher reaction temperature of 1000° C. Also, full MoOₓ microspheres (hereafter referred to as ‘F-MoOₓ microspheres’) were manufactured by spray pyrolysis using a spray solution including only (NH₄)₆Mo₇O₂₄·4H₂O without PVP or DETA at 800° C.

### Experimental Example 1—Observation of Morphology of Microspheres Depending on Spray Pyrolysis Temperature

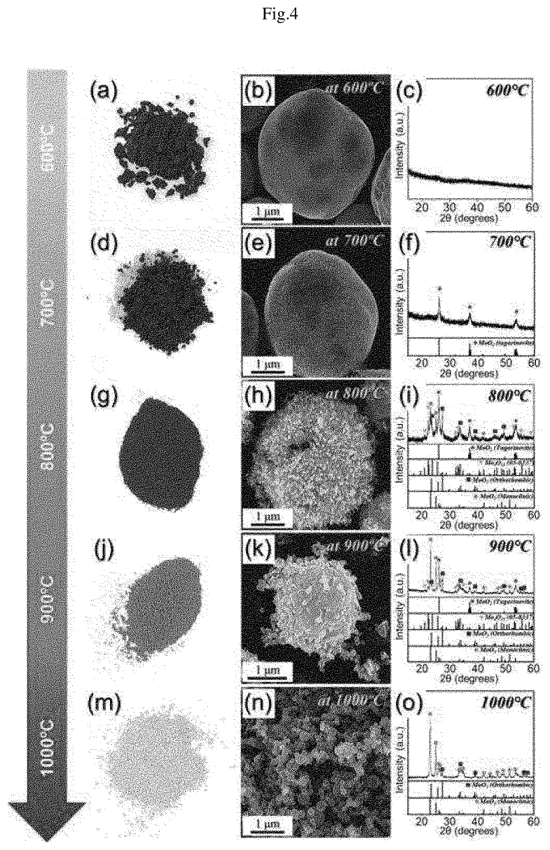

The morphology of microspheres obtained from the spray solution including Mo salt, PVP, and DETA was observed at various reaction temperatures. Referring to FIG. 4, the morphology thereof was confirmed by increasing the reaction temperature from 600° C. to 1000° C.

Referring to FIGS. 4(d), 4(e), and 4(f), the droplets formed by the ultrasonic nebulizer were gradually dried while passing through the reactor, and at 700° C., MoOₓ crystals began to precipitate in the structure.

Referring to FIGS. 4(g), 4(h), and 4(i), one-dimensional rod-shaped crystals having various MoOₓ phases were formed at 800° C.

Referring to FIGS. 4(j), 4(k), and 4(l), the MoO₃ crystals were sintered at 900° C., and MoO₃ rods aggregated into lumpy spheres.

Referring to FIGS. 4(m), 4(n), and 4(o), at temperatures of 1000° C. or higher, carbon between the attached MoO₃ particles was completely decomposed into gas, and the MoO₃ particles were separated, forming independent MoO₃ nanocubes. Referring to the X-ray diffraction (XRD) data of FIGS. 4(c), 4(f), 4(i), 4(l), and 4(o), as the reaction temperature increased from 600° C. to 1000° C., the peak intensity of the oxygen-deficient MoO₂ phase gradually decreased and was not observed at 1000° C., while the peak intensity of the oxygen-rich MoO₃ phase increased, and only the MoO₃ phase was confirmed at 1000° C. This is because the PVP and DETA additives in the droplets create a reducing atmosphere during pyrolysis at low reaction temperatures. Furthermore, the color of the microspheres changed from black to green, confirming gradual removal of carbon. Therefore, in this experimental example, it was confirmed that the optimal temperature was 800° C. and also that MoOₓ nanorods were entangled with an appropriate amount of carbon at this temperature, yielding sea urchin-like hollow microspheres of the present invention.

### Experimental Example 2—Observation of Morphology of Microspheres According to Comparative Examples

It was confirmed that the interaction between Mo salt, PVP, and DETA had a significant effect on the morphology of microspheres. Referring to FIGS. 5(a) to 5(c), the microspheres obtained from the spray solution including only the Mo salt had a full spherical structure. Also, referring to FIGS. 5(d) to 5(f), when PVP polymer was added to the Mo salt, a full structure similar to the above structure was obtained. However, the decomposition of PVP induced a reducing atmosphere, forming oxygen-deficient MoO₂ and Mo₄O₁₁ phases. Referring to FIGS. 5(g) to 5(i), microspheres obtained from the spray solution including Mo salt and DETA included rod-shaped and plate-shaped crystals. Specifically, when DETA was contained in the spray solution, rod-shaped crystals were formed. However, aggregation was inhibited due to the absence of carbon between the rods, forming a bulky plate shape in the microspheres. Therefore, through Experimental Examples 1 and 2 above, it was confirmed that the microspheres having the novel structure of the present invention were manufactured by controlling the reaction temperature and the interaction between Mo salt, PVP, and DETA during spray pyrolysis.

### Experimental Example 3—Observation of Morphology of Microspheres According to Example

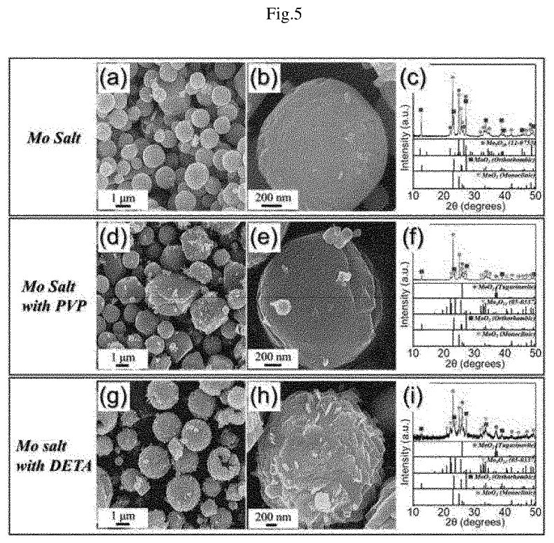

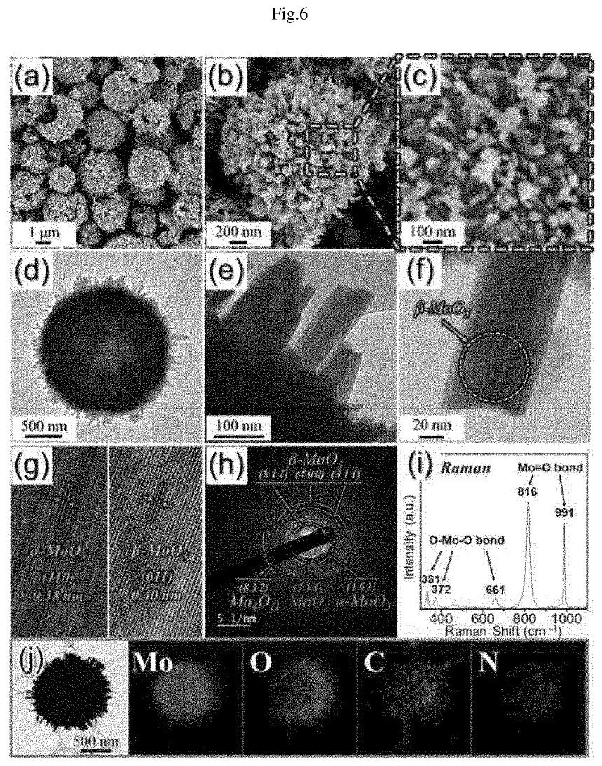

The morphology of microspheres according to Example of the present invention was observed. Referring to FIGS. 6(a) to 6(c), it can be seen that the microspheres of the present invention are spherical with an average size of 2.4 μm and are composed of numerous nanorods with a width of 50 nm and a height of 200 to 500 nm. Referring to FIG. 6(d), it was confirmed through transmission electron microscopy (TEM) that the inside of the powder appeared bright due to the hollow structure, and also that the formed nanorods were attached to each other to form a hollow shell. Referring to FIGS. 6(e) and 6(f), one-dimensional rod-shaped MoO₃ crystals were formed in the z-axis. Referring to FIG. 6(g), as shown in the high-resolution (HR)-TEM images, clear lattice fringes with widths of 0.38 nm and 0.40 nm were confirmed, which correspond to the (110) crystal plane of α-MoO₃ and the (011) crystal plane of β-MoO₃, respectively. Referring to FIG. 6(h), the oxygen-deficient MoO₂ and Mo₄O₁₁ phases were confirmed along with the two MoO₃ phases through the SAED (selected area electron diffraction) pattern. Referring to FIG. 6(i), the results of phase analysis are consistent with the XRD results for SUHM-MoOₓ/NC. Referring to FIG. 6(j), homogeneous distribution of elements Mo, O, C, and N throughout the structure was confirmed, and uniform formation of molybdenum oxide was confirmed during spray pyrolysis.

### Experimental Example 4—Analysis of Amounts of C and N of Microspheres

Based on thermogravimetry (TG), the amounts of carbon and nitrogen were calculated, and the results thereof are shown in Table 1 below. Specifically, the amounts of C and N of SUHM-MoOₓ/NC microspheres according to Example were estimated to be 3.9 wt % and 2.7 wt %, respectively. Small amounts of N and C are expected to enable efficient transfer of electrons without reducing cell capacity during cycling.

TABLE 1

| Sample | Carbon (wt %) | Nitrogen (wt %) |
|---|---|---|
| SUHM-MoOₓ/NC | 3.9 | 2.7 |

### Experimental Example 5—Evaluation of Electrochemical Performance

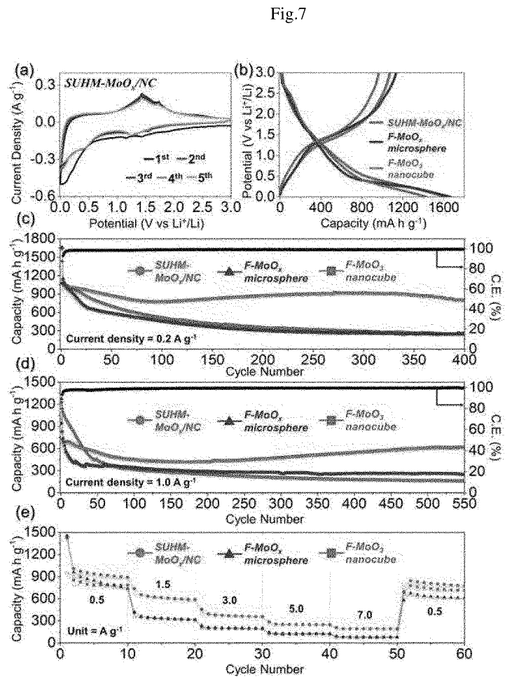

The electrochemical performance of SUHM-MoOₓ/NC as Example, F-MoO₃ nanocubes as Comparative Example, and F-MoOₓ microspheres as another Comparative Example was evaluated. FIG. 7(a) shows results of cyclic voltammetry (CV) of Example, representing the cycling for the first 5 cycles at a scan rate of 0.1 mV s⁻¹ in the range of 0.001 to 3.0 V. The broad peak at 1.85 V observed only in the first cycle during the first cathodic scan is due to Li ions entering the crystalline Mo₄O₁₁ and MoO₃ phases to form LiₓMoOₓ. The two subsequent peaks at 1.43 V and 1.16 V are due to the intercalation of Li ions into MoO₂ crystals to form LiₓMoO₂ during Li intercalation. Furthermore, the broad cathodic peaks at 0.21 V and 0.05 V suggest that LiₓMoOₓ and LiₓMoO₂ are converted into metallic Mo and Li₂O, respectively, and also that Li ions are intercalated into N-doped C. The peaks at 1.43 V and 1.73 V during the first cathodic scan are attributed to the conversion of metallic Mo and Li₂O into MoO₂ and LiₓMoO₂. From the second cycle, the cathodic peak for the interaction of Li and MoO₂ shifts to a slightly higher voltage due to the formation of ultrafine nanocrystals of MoO₂, while the anodic peak appears at the same potential with a slight decrease in intensity. The CV curve after the first cycle suggests a reversible redox process.

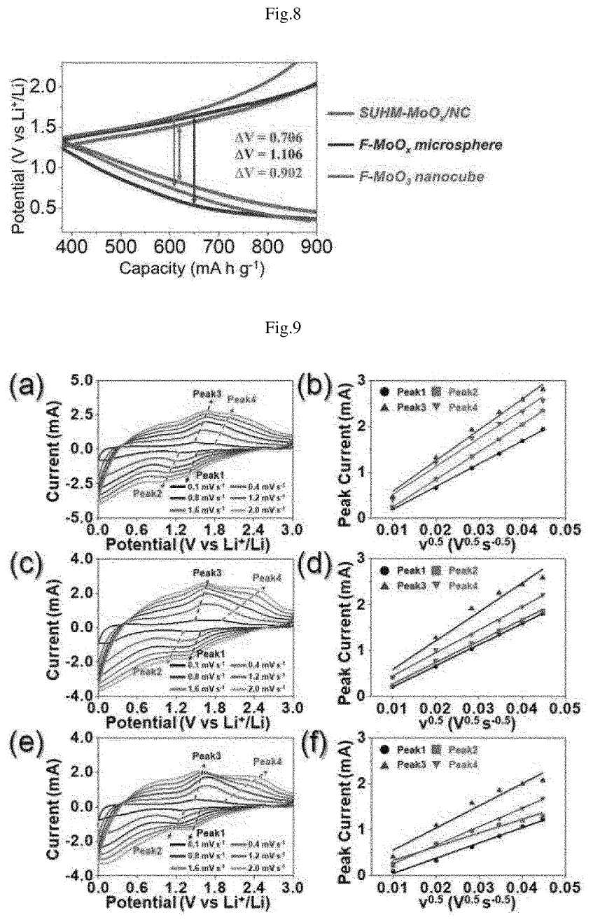

FIG. 7(b) shows the initial discharge-charge profiles of Example and Comparative Examples at a current density of 0.2 A g⁻¹. The obtained potential profiles are consistent with the CV results, with discharge and charge being stable at 0.26 V and 1.54 V, respectively. Furthermore, the initial discharge capacities of SUHM-MoOₓ/NC, F-MoOₓ microspheres, and F-MoO₃ nanocubes are 1638, 1664, and 1434 mA h g⁻¹ and the Coulombic efficiency (CE) values thereof are 65%, 68%, and 67%, respectively. Although SUHM-MoOₓ/NC has carbon with high initial irreversible capacity loss in the structure, there is no great difference from the other structures in view of CE due to the structural advantages of SUHM-MoOₓ/NC. Meanwhile, referring to FIG. 8, SUHM-MoOₓ/NC shows the lowest polarization potential (ΔV=0.706 V) compared to F-MoOₓ microspheres (ΔV=1.106 V) and F-MoO₃ nanocubes (ΔV=0.902 V), indicating that SUHM-MoOₓ/NC has improved electronic and ionic conductivity.

FIG. 7(c) shows the cycling performance of Example and Comparative Examples at a current density of 0.2 A g⁻¹. SUHM-MoOₓ/NC exhibited superior cycling performance compared to F-MoOₓ microspheres and F-MoO₃ nanocubes over 400 cycles. The hollow and porous structure of SUHM-MoOₓ/NC is capable of efficiently absorbing mechanical stress induced by repeated Li ion diffusion during cycling. The discharge capacity of SUHM-MoOₓ/NC is 794 mA·h·g⁻¹ at the 400th continuous discharge/charge cycle, and the capacity decay rate measured from the second cycle is 0.074%. In contrast, the discharge capacities of F-MoOₓ microspheres and F-MoO₃ nanocubes were continuously reduced to 238 and 258 mA h g⁻¹, respectively, at the 400th cycle, and the capacity decay rates measured at the second cycle were 0.1986% and 0.1888%, respectively. Therefore, it can be found that the large volume change due to the full structure of Comparative Examples is not accommodated during repeated Li ion intercalation, ultimately resulting in a rapid decrease in capacity.

FIG. 7(d) shows the cycling performance of Example and Comparative Examples at a higher current density of 1.0 A g⁻¹. SUHM-MoOₓ/NC shows a discharge capacity of 618 mA h g⁻¹ at the 550th cycle, indicating stable discharge capacity even at high current density. However, F-MoOₓ microspheres and F-MoO₃ nanocubes showed a sharp decline slope, and respective discharge capacities thereof were 248 and 162 mA h g⁻¹ at the 550th cycle. Specifically, the hollow and porous structure of SUHM-MoOₓ/NC is capable of effectively accommodating volume expansion induced by repeated intercalation/deintercalation of Li⁺ ions, the N-doped C with high electrical conductivity induces fast charge transfer during cycling, and the MoOₓ nanorods that make up the shell enable fast lithium ion diffusion, resulting in high specific capacity and stable cycling performance.

FIG. 7(e) shows results of observation of the rate performance of Example and Comparative Examples at current density gradually increasing from 0.5 to 7.0 A g⁻¹. The final discharge capacities of SUHM-MoOₓ/NC at current densities of 0.5, 1.5, 3.0, 5.0, and 7.0 A g⁻¹ are 891, 589, 358, 250, and 193 mA·h g⁻¹, respectively. When the current density is lowered again to 0.5 A g⁻¹, the discharge capacity of SUHM-MoOₓ/NC is well returned to 843 mA·h g⁻¹. On the other hand, F-MoOₓ microspheres and F-MoO₃ nanocubes showed discharge capacities of 787/740, 313/315, 201/190, 128/120, and 81/75 mA h g⁻¹, respectively, at the same current densities, which is inferior to Example. Thus, Example exhibited structural superiority for LIBs compared to Comparative Examples having the full structure. In Example, numerous MoOₓ nanorods promote electrochemical reaction by increasing the contact area with the electrolyte. Also, the optimal amount of N-doped C with high electrical conductivity used to coat and attach MoOₓ nanorods is capable of promoting fast electron transfer during cycling.

To further confirm excellent performance of Example, lithium ion diffusion coefficients (D_{Li+}) were compared. All samples were cycled from 0.1 to 2.0 mV s⁻¹ and the corresponding CV curves are shown in FIGS. 9(a), 9(c), and 9(e). The CV curves have two cathodic peaks, labeled “Peak 1” at 1.45 V and “Peak 2” at 1.23 V, and two anodic peaks, labeled “Peak 3” at 1.48 V and “Peak 4” at 1.75 V. These peaks are due to the electrochemical interaction between Li ions and MoO₂ formed during reversible phase transition. Lithium ion diffusion coefficient (D_{Li+}) is calculated using the following Randles-Sevcik equation.

$$Ip = 2.69 \times {10}^{5} {n}^{1.5} {AD}_{Li +}^{0.5} {C}_{LiB} {v}^{0.5}$$

Here, D_{Li+} is the lithium ion diffusion coefficient (cm² s⁻¹), Iₚ is the cathodic/anodic peak current (A), n is the number of electrons involved in reaction (n=4), A is the electrode area (cm²), C_{Li} is the lithium ion concentration (mol L⁻¹), and vis the scan rate (V s⁻¹). Graphs showing the relationship between cathodic/anodic peak current, Iₚ, and square root of scan rate (v^{0.5}) for three different structures are shown in FIGS. 9(b), 9(d), and 9(f). Also, the lithium ion diffusion coefficient values are shown in Table 2 below.

TABLE 2

| | | | | | Avg. |
|---|---|---|---|---|---|
| | D_{Li+}(cm²s⁻¹) × 10⁻¹⁰ | | | | D_{Li+}(cm²s⁻¹) × |
| Sample | Peak A | Peak B | Peak C | Peak D | 10⁻¹⁰ |
| SUHM-MoOₓ/NC | 2.27 | 3.32 | 4.13 | 3.44 | 3.29 |
| F-MoOₓ | 1.95 | 2.00 | 3.63 | 2.33 | 2.48 |
| microsphere | | | | | |
| F-MoO₃ | 1.01 | 0.83 | 2.15 | 1.50 | 1.38 |
| nanocube | | | | | |

Referring to Table 2, the average diffusion coefficient values of SUHM-MoOₓ/NC, F-MoOₓ microspheres, and F-MoO₃ nanocubes were determined to be 3.29×10⁻¹⁰, 2.48×10⁻¹⁰, 1.38×10⁻¹⁰ cm² s⁻¹, respectively. Here, SUHM-MoOₓ/NC shows the highest D_{Li+} value among the samples, indicating faster Li ion diffusion and a high redox reaction rate during the charge-discharge process, which can ultimately contribute to improving energy storage performance.

Referring to FIG. 9, excellent lithium ion storage properties of SUHM-MoOₓ/NC were confirmed by electrochemical impedance spectroscopy (EIS) of the cell before and after the first and 100th cycles in a fully charged state. Referring to FIG. 9(a), the Nyquist plot for the initial fresh cell shows slightly different resistance (Rs) values in the range of 24-39Ω, indicating slightly different electrode-electrolyte interface reaction. Moreover, respective charge transfer resistance (R_{ct}) values of SUHM-MoOₓ/NC, F-MoOₓ microspheres, and F-MoO₃ nanocubes are 103, 228, and 100Ω. The full structure of F-MoOₓ microspheres influences an increase in Rot value of the cell.

However, referring to FIG. 9(c), due to the formation of ultrafine MoO₂ crystals in the structure after the first cycle, the R_{ct} value after the first cycle was 51Ω for SUHM-MoOₓ/NC, 53Ω for F-MoOₓ microspheres, and 28Ω for F-MoO₃ nanocubes, indicating a significant reduction in all samples.

Referring to FIG. 9(e), after the 100th cycle, the R_{ct} value of SUHM-MoOₓ/NC was 367Ω, which is regarded as the lowest R_{ct} compared to F-MoOₓ microspheres (933Ω) and F-MoO₃ nanocubes (955Ω). This suggests a high redox reaction rate and excellent electrode integrity.

To confirm the structural integrity of SUHM-MoOₓ/NC, FE-SEM images of Example and Comparative Examples were confirmed after the 100th cycle at a current density of 0.2 A g⁻¹. Referring to FIG. 9(b), after cycling, SUHM-MoOₓ/NC shows the morphology of microspheres with MoOₓ nanorods on the surface. The hollow and porous structure is capable of accommodating structural stress resulting from the large volume change of MoOₓ constituting the shell induced by Li ion diffusion during repeated cycling. However, referring to FIGS. 9(d) and 9(f), F-MoOₓ microspheres and F-MoO₃ nanocubes showed complete structural decomposition into bulk lumps after cycling because they were incapable of withstanding volume changes.

In conclusion, SUHM-MoOₓ/NC microspheres exhibit excellent lithium ion storage properties, and the unique hollow and porous structure thereof alleviates large volume changes and facilitates electrolyte penetration. Also, N-doped C and MoOₓ nanorods attached thereto contribute to an increase in electrical conductivity of the electrode, leading to fast charge transfer during cycling. Furthermore, the MoOₓ nanorods that make up the shell enable fast lithium ion diffusion and improve electrical contact between microspheres.

As described hereinbefore, preferred embodiments of the present invention have been mainly described. Those skilled in the art to which the present invention belongs will understand that the present invention may be implemented in a modified form without departing from the essential characteristics of the present invention. Therefore, the disclosed embodiments are to be considered from a descriptive point of view rather than a limited point of view. The scope of the present invention is indicated in the claims rather than the foregoing description, and all differences within the scope equivalent thereto should be construed as being included in the present invention.

### INDUSTRIAL APPLICABILITY

According to the present invention, microspheres have excellent lithium ion storage performance and can be applied to a high-performance anode for a lithium ion battery. Moreover, the microspheres of the present invention can be synthesized by a simple method and are therefore suitable for mass production.

1. Microspheres, comprising:
hollow carbon; and
a transition metal oxide disposed on a surface of the hollow carbon.

2. The microspheres according to claim 1, wherein the transition metal oxide is nanorod-shaped.

3. The microspheres according to claim 1, wherein the transition metal oxide is-includes at least one selected from the group consisting of MoOₓ, NiO, SnO₂, Co₃O₄, WO₃, NbO, TiO₂, and Fe₂O₃.

4. The microspheres according to claim 2, wherein the nanorod has a width of 20 nm to 80 nm and a height of 200 nm to 500 nm.

5. The microspheres according to claim 1, wherein the hollow carbon is N-doped carbon.

6. The microspheres according to claim 1, wherein the microspheres comprise 2.0 wt % to 5.0 wt % of carbon and 1.5 wt % to 3.5 wt % of nitrogen based on a total weight thereof.

7. An anode for a lithium ion battery comprising the microspheres according to claim 1.

8. A method of manufacturing microspheres, comprising:
obtaining a spray solution by mixing a metal salt, a carbon precursor, and an ammonium ion precursor; and
subjecting the spray solution to one-pot spray pyrolysis.

9. The method according to claim 8, wherein the spray pyrolysis is performed at a temperature of 600° C. to 1000° C.

10. The method according to claim 8, wherein there is no subsequent heat treatment process after the spray pyrolysis.

11. The method according to claim 8, wherein the metal salt is-includes at least one selected from the group consisting of salts of Mo, Ni, Sn, Co, W, Nb, Ti, and Fe.

12. The method according to claim 8, wherein the carbon precursor comprises at least one selected from the group consisting of PVP (polyvinylpyrrolidone), PEDOT (polyethylenedioxythiophene), PAN (polyacrylonitrile), PAA (polyacrylic acid), PVA (polyvinyl alcohol), PMMA (polymethyl methacrylate), PVDF (polyvinylidene fluoride), PVAc (polyvinyl acetate), PS (polystyrene), PVC (polyvinyl chloride), PEI (polyetherimide), PBI (polybenzimidazole), PEO (polyethylene oxide), PCL (poly e-caprolactone), PA-6 (polyamide-6), PTT (polytrimethylene terephthalate), PDLA (poly D,L-lactic acid), polycarbonate, polydioxanone, polyglycolide, and dextran.

13. The method according to claim 8, wherein the ammonium ion precursor is diethylenetriamine (DETA).
